(19) United States
(12) Patent Application Publication
(10) Pub. No.: US 2012/0097854 A1
(43) Pub. Date: Apr. 26, 2012

(54) INFRARED RETROREFLECTING DEVICE USED FOR A HIGH-ASPECT-RATIO OPTICAL TOUCH PANEL, THE METHOD OF MANUFACTURING THE SAME AND A HIGH-ASPECT-RATIO TOUCH PANEL USING SUCH DEVICE

(76) Inventor: Lok-Man Ng, Hsinchu City (TW)

(21) Appl. No.: 13/375,414

(22) PCT Filed: Jun. 1, 2010
(86) PCT No.: PCT/US10/36794

§ 371 Date: Dec. 22, 2011

(30) Foreign Application Priority Data
Jun. 1, 2009 (TW) 098118143
Jun. 2, 2009 (CN) 200910146421.4

(51) Int. Cl. G01J 5/02; B26D 3/00; B32B 38/04; B32B 37/12; B32B 37/06; G02B 5/122; B32B 37/14

(52) U.S. Cl. 250/353; 359/351; 83/13; 156/250

(57) ABSTRACT

An infrared retroreflecting device used for a high-aspect-ratio optical touch panel, comprising an infrared retroreflecting stripe having a front surface, a back side and an elongated axis; the stripe being formed of a cube-corner retroreflecting structure having a primary groove and at least two secondary grooves; the primary groove being perpendicular to the elongated axis; and the stripe reflecting infrared emitted toward the front surface when an infrared incident angle is ranged from about 0° to about 61°. A method of manufacturing an infrared retroreflecting device used for a high-aspect-ratio optical touch panel, comprising forming a cube-corner retroreflecting sheet having a front surface, a back side, a first direction and a second direction, said first direction being perpendicular to the second direction, and cutting a retroreflecting stripe from said cube-corner retroreflecting sheet in the second direction. A high-aspect-ratio optical touch panel using the aforementioned infrared retroreflecting device is also disclosed.

### FIELD OF THE INVENTION

The present invention is related to an infrared retroreflecting device used for a high-aspect-ratio optical touch panel, the method of manufacturing such device and a high-aspect-ratio optical touch panel using such device, particularly to an infrared retroreflecting device which is used for a panel with a high aspect ratio and reflects sufficient amount of infrared, and the method of manufacturing and using such a device.

### BACKGROUND

Touch panels are becoming widely used and bigger in size. The normal aspect ratio of a touch panel used to be 4:3, while a 16:9 aspect-ratio touch panel is now more popular.

The current touch panels comprise resistive touch panels, capacitive touch panels and optical touch panels. The resistive touch panels were developed early. Since a resistive touch panel has a multi-laminated structure, its transmittance is influenced and it is easily scraped. Further, on a resistive touch panel, only one touch point can be handled at a time. As to the capacitive touch panel, even though it has better transmittance, it is still necessary to build an electric field on the entire panel by lamination, so as to sense the variance of the capacitance. The larger the panel, the more limitations on the materials and production, and the higher the costs. One of the advantages of an optical touch panel is that there is no laminated layer attached to the surface of the panel and therefore the transmittance is not influenced.

A conventional optical touch panel, such as the one disclosed in U.S. Pat. No. 3,764,813, needs pairs of light emitters and receivers (detectors) distributed at the four edges of the panel. A modern optical touch panel, such as the one disclosed in U.S. Pat. No. 4,507,557, uses two sets of infrared emitters and receivers (detectors). With the use of retroreflecting material, it can detect the position of a touch point on the panel. Such a panel not only is simple in structure, but also requires fewer elements. Further, no lamination on a large area is required. Such a modern optical panel has advantages in terms of production and cost. As to the technique of retroreflecting material, it is disclosed in PCT Pub. No. WO 2006/096258 and U.S. Pat. No. 5,200,851.

However, an optical touch panel which uses very few light emitters and receivers has a notable disadvantage; namely, the retroreflecting material cannot sufficiently and stably reflect light emitted at a large incident angle to light receivers, so the panel cannot be used for a screen with a high aspect ratio. For example, for a screen with a 16:9 aspect ratio, the maximum incident angle of the light emitted that the retroreflecting material can receive exceeds 60°; as a result, no sufficient light, or even no light at all, can be reflected to light receivers. Particularly, when the surface of the retroreflecting material is covered with a colored film to make it consistent with the overall appearance of the panel, since the amount of light emitted to the retroreflecting material is decreased, the maximum incident angle of the emitted light that the retroreflecting material can receive is decreased.

### SUMMARY

The present inventors thus have identified a need for a retroreflecting device which can reflect sufficient amount of light emitted at a large incident angle to optical receivers. Such a technique is necessary in developing a high-aspect-ratio optical touch panel.

Accordingly, an objective of an embodiment of the present invention is to provide an infrared retroreflecting device which can still provide retroreflection when the infrared is emitted at a large incident angle.

Another objective of an embodiment of the present invention is to provide a method of manufacturing an infrared retroreflecting device which can still provide retroreflection when the infrared is emitted at a large incident angle.

A further objective of an embodiment of the present invention is to provide a high-aspect-ratio optical touch panel using such infrared retroreflecting device.

The present invention relates to an infrared retroreflecting device used for a high-aspect-ratio optical touch panel, comprising: an infrared retroreflecting stripe; the stripe having a front surface, a back side and an elongated axis; the stripe being formed of a cube-corner retroreflecting structure which has at least one primary groove and at least two secondary grooves and is beneath the front surface; the primary groove being perpendicular to the elongated axis; and the stripe reflecting infrared emitted toward the front surface when an infrared incident angle is ranged from about 0° to about 61°.

The present invention also relates to a method of manufacturing an infrared retroreflecting device used for a high-aspect-ratio optical touch panel, comprising the following steps: forming a cube-corner retroreflecting sheet which has a front surface, a back side, a first direction and a second direction, said first direction being perpendicular to the second direction, and cutting a retroreflecting stripe from said cube-corner retroreflecting sheet in the second direction.

The present invention further relates to a high-aspect-ratio optical touch panel, comprising: a first edge and a second edge opposite to the first edge; a third edge and a fourth edge opposite to the third edge, both the third edge and fourth edge being perpendicular to the first edge and the second edge; two infrared detectors located near two ends of the first edge of the panel, the infrared detectors being able to emit infrared to the second edge of said panel and receive the infrared, an infrared retroreflecting device located at the second edge of the panel; the infrared retroreflecting device having an infrared retroreflecting stripe, the stripe having a front surface facing the infrared detectors, a back side and an elongated axis; the stripe being formed of a cube-corner retroreflecting structure which has at least one primary groove and at least two secondary grooves, and is beneath the front surface; the primary groove being perpendicular to the elongated axis, and the infrared retroreflecting device reflecting sufficient infrared from each location along the infrared retroreflecting device so that the reflected infrared can be detected by both of the infrared detectors.

The present invention further relates to a high-aspect-ratio optical touch panel using the infrared retroreflecting device made according to the method of manufacturing an infrared retroreflecting device stated above.

The infrared retroreflecting device of the present invention can include a colored layer with good infrared transmittance and further include a backing layer and an adhesive layer as desired.

According to the present invention, a high-aspect-ration optical touch panel can be made easily, at a low cost.

### BRIEF DESCRIPTION OF THE DRAWINGS

FIG. 1 is a schematic view illustrating a high-aspect-ratio optical touch panel in accordance with the an embodiment of present invention;

FIG. 2 is a schematic view illustrating a working area (namely, the area that the infrared detectors can detect) of an optical touch panel when first, second and third edges thereof are provided with an infrared retroreflecting device;

FIG. 3 is a perspective view of an infrared retroreflecting device in accordance with an embodiment of the present invention;

FIG. 4 is an enlarged view illustrating a cube-corner retroreflecting structure of the infrared retroreflecting device in accordance with an embodiment of the present invention, seen from the back side 305 of the infrared retroreflecting device;

FIG. 5 is a side view illustrating a cube-corner retroreflecting structure used in the infrared retroreflecting device in accordance with an embodiment of the present invention;

FIG. 6 is a schematic view illustrating the infrared retroreflection function by the cube-corner retroreflecting structure;

FIG. 7 is an enlarged view illustrating a cube-corner retroreflecting structure of the infrared retroreflecting device in accordance with an embodiment of the present invention, seen from the back side 305 of the infrared retroreflecting device and from the direction perpendicular to that taken in FIG. 4;

FIG. 8 is a schematic view of a cube-corner retroreflecting structure of the infrared retroreflecting device in accordance with an embodiment of the present invention;

FIG. 9 is a schematic view illustrating the partial retroreflection state of the infrared retroreflecting device, when the incident angle is in a range from about 30° to 60°; and

FIG. 10 is a schematic view illustrating the partial retroreflection state of the infrared retroreflecting stripe which is not cut along the second direction, when the incident angle is in a range from about 30° to 60°.

### DETAILED DESCRIPTION

The preferred embodiments of the present invention are illustrated in the following description in conjunction with accompany drawings, in which the reference numerals are used to represent corresponding elements.

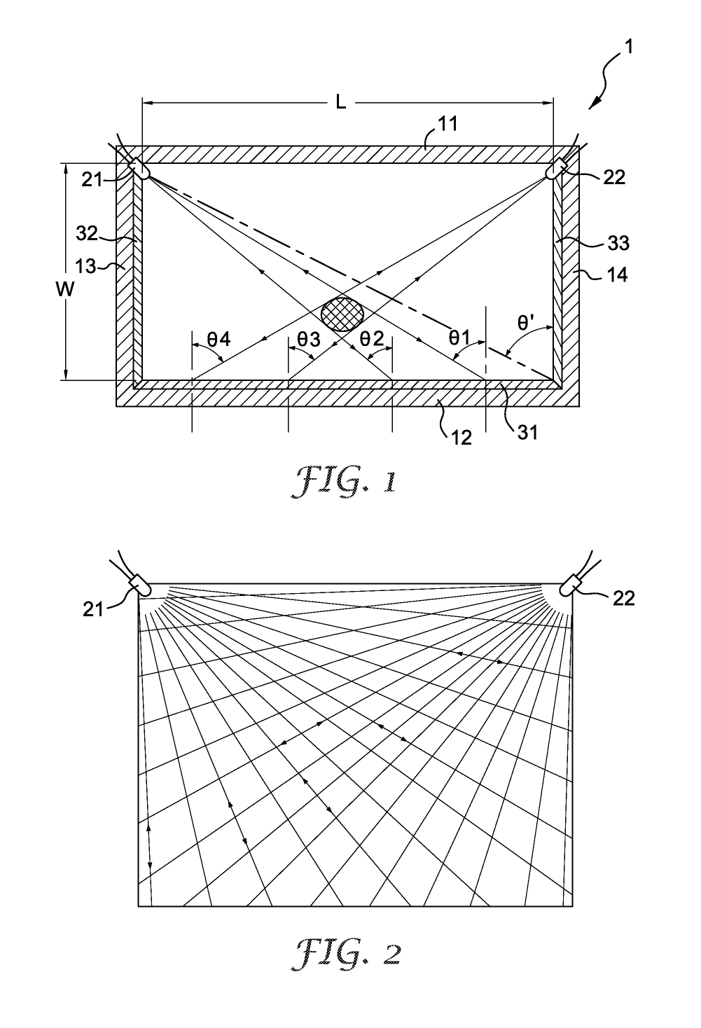

FIG. 1 shows a high-aspect-ratio optical touch panel 1 with a working area surrounded by four edges. The two ends of the first edge 11 respectively connect the third edge 13 and the fourth edge 14 opposite to the third edge 13, and the two ends of the second edge 12 respectively connect the third edge 13 and the fourth edge 14 too. The first edge 11 and the second edge 12 are substantially perpendicular to the third edge 13 and the fourth edge 14 respectively to form a substantially rectangular working area. Two infrared detectors 21 and 22 are disposed near the two ends of the first edge 11. Infrared detectors 21 and 22 respectively include a LED, which is a point light source able to emit infrared to surroundings, and an infrared detecting device, which is able to detect infrared from all directions and transform the detected light to electronic signals to be received by a calculation processing unit (not shown in the drawings). An infrared retroreflecting device 31 is very close to the surface of the second edge 12 facing the working area.

Retroreflection is that almost all incident lights are reflected back along the same light directions. An angle formed by an incident light and the surface that the incident light projects to is called an incident angle θ, which is defined as the angle formed between the direction of the incident light and the normal direction of the surface that the light projects to. For a panel with a length-width ratio of 16:9 (FIG. 1), the smallest incident angle is zero, which is formed by the infrared emitted from the infrared detector 21 and the position on the second edge 12 right opposing to the infrared 21, and the largest incident angle θ′ is about 60.6 °, which is formed by the same infrared and the diagonal position on the second edge 12. A conventional retroreflection device is not capable of reflecting lights of the incident angle 60° (as shown on the right of FIG. 10). However, the retroreflecting device 31 of the present invention is still capable of reflecting the infrared of the incident angle about 0°-60° from the infrared detector 21 or 22, so that infrared detectors 21 and 22 still can receive optical signals in such range of incident angle.

When there is an object in the working area of the panel, as shown in FIG. 1, the infrared emitted from the LED of the infrared detector 21 in the area between the incident angles θ1 and θ2 will be blocked and thus cannot reach the retroreflecting device 31. Therefore, no infrared at this area is returned back to the infrared detector 21 by the retroreflecting device 31. Similarly, the infrared emitted from the LED of the infrared detector 22 in the area between the incident angles θ3 and θ4 will be blocked by the object. Therefore, no infrared at this area is returned back to the infrared detector 22. The reflected infrared is transformed to electronic signals and these signals are processed by the calculation process unit. The position of the object in the working area can therefore be accurately identified. A preferred embodiment is to further arrange an infrared retroreflecting device 32, 33 at the locations facing the working area and close to the third edge 13 and the fourth edge 14, respectively. By doing so, any position of the working area that an object blocking lights is placed can be successfully detected (FIG. 1 and FIG. 2).

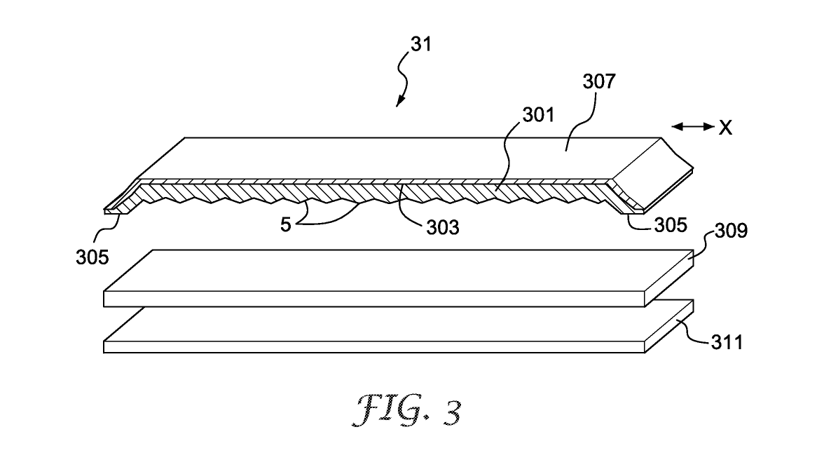

The retroreflecting device 31 of the present invention is still capable of reflecting the infrared of the incident angle about 0°˜60′from the infrared detector 21 or 22, so that infrared detectors 21 and 22 still can receive light signals in such range of incident angle. By means of the present invention, a high-aspect-ratio optical touch panel is practicable. The infrared retroreflecting devices 32 and 33 can be of the same structure and function as the retroreflecting device 31. Such a retroreflecting function at a large incident angle is achieved by the following technique: As shown in FIG. 3, an infrared retroreflecting device 31 has an infrared retroreflecting stripe 301, which is formed of a cube-corner retroreflecting structure 5. Said infrared retroreflecting stripe 301 has a front surface 303, which faces the infrared detectors 21 and 22 and is the surface that lights project to; the infrared retroreflecting stripe 301 also has a back side 305 and an elongated axis X, which represents the extension direction of the retroreflecting stripe 301. The back side 305 is the bottom area of the infrared retroreflecting stripe 301; it is not necessarily a plane.

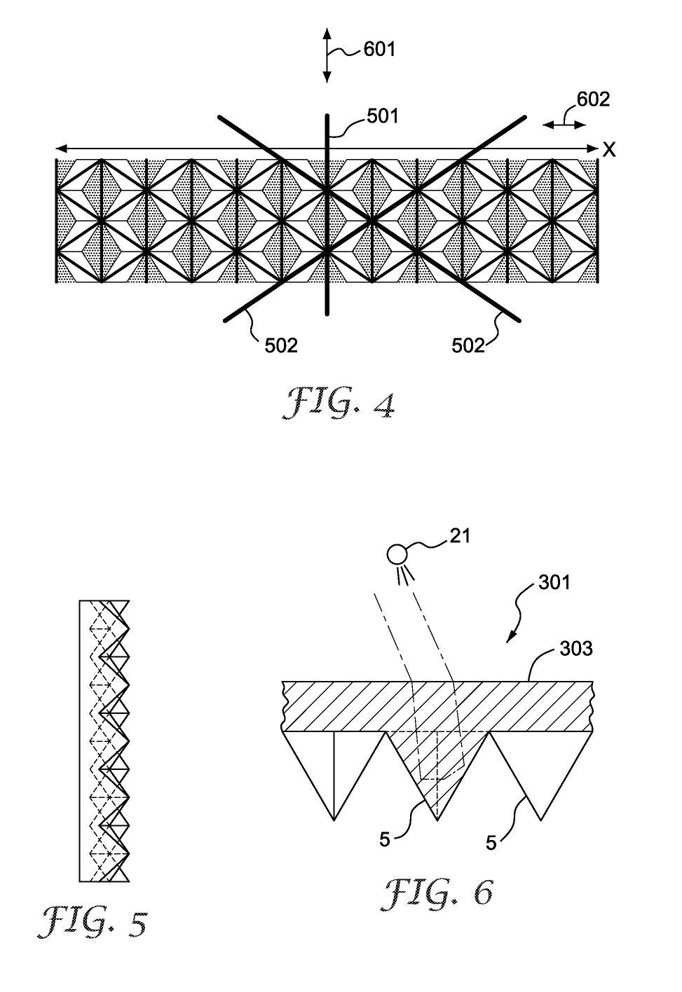

The cube-corner retroreflecting structure 5 is substantially comprised of a plurality of pyramid-like structures or cube-corners cut from a hollow cube; these cube-corner structures can be of the same size or not completely the same (FIG. 4 and FIG. 5). The cube-corner structure acts as a prism (FIG. 6). Incident lights project to the front surface 303 and then pass through the material (which is usually a kind of polymer transmissive to both visible lights and infrared lights, such as PMMA (polymethyl methacrylate)) of which the cube-corner structure is made. When the lights reach the surface of the cube-corner structure and encounter a less optically dense medium, which is usually the air, the lights are retroreflected. The angle of reflection is substantially the same as the incident angle. Because these cube-corner structures are very tiny and distributed on the retroreflecting stripe 301 beneath the front surface 303, the reflected infrared returns to the infrared detectors 21 and 22 substantially in the directions of the incident lights. The principle of retroreflection mentioned in U.S. Pat. No. 5,200,851 can be a reference.

FIG. 4 shows the cube-corner rertoreflecting structures of the retroreflecting stripe 301 seen from the back side 305. Such structure has the property of anisotropic orientation. Both of FIG. 7 and FIG. 4 show the structures seen from the back side 305 of the retroreflecting stripe 301, but FIG. 7 is the rotated FIG. 4 at 90 ° on a horizontal plane. The patterns shown in FIGS. 4 and 7 are not identical. Because of the anisotropic orientation property, the capability of reflecting lights is not isotropic in different directions.

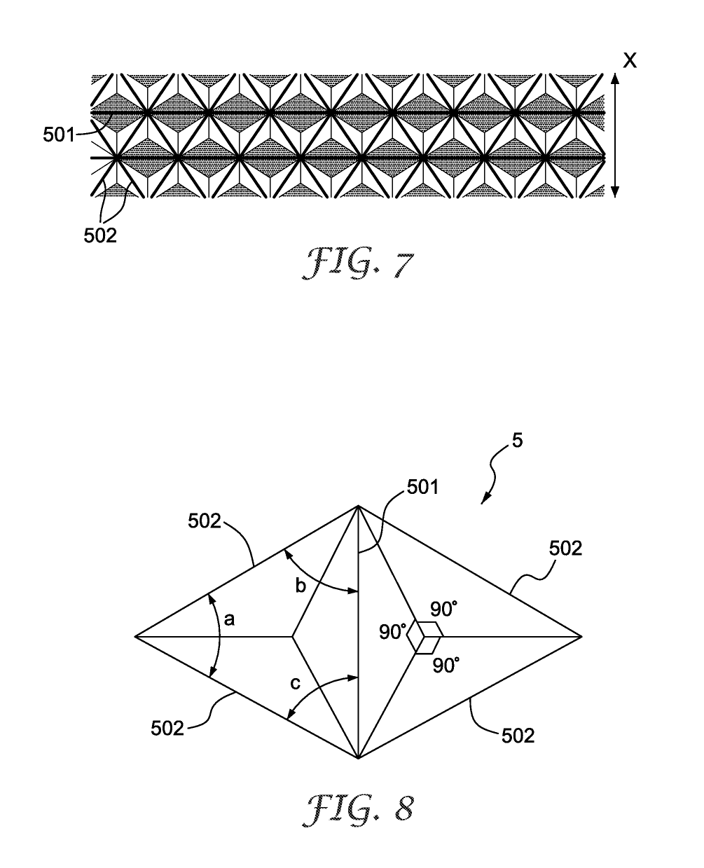

FIG. 4 shows the shape of the infrared retroreflecting stripe 301 seen from the back side 305; a plurality of primary grooves 501 and a plurality of secondary grooves 502 are formed thereon. Said primary grooves 501 are a series of concaved regions formed by two triangular surfaces adjacent and symmetrical to each other of each pair of the adjacent cube-corner structures. The primary grooves 501 are perpendicular to the elongated axis X. The plane that makes two triangular surfaces adjacent to each other of each pair of the adjacent cube-corner structures is defined as a first direction 601. The plane perpendicular to the first direction 601 is defined as the second direction 602. Said first direction 601 and second direction 602 are the two planes perpendicular to the front surface 303 of the retroreflecting stripe 301. The secondary grooves 502 are a series of concaved regions formed by two triangular surfaces adjacent and asymmetrical to each other of each pair of the adjacent cube-corner structures. As to a single cube-corner structure, the secondary grooves 502 extends along the two surfaces other than the surface on which the primary groove 501 extends, as shown in FIG. 4 and FIG. 8. In other words, a single cube-corner retroreflecting structure has one primary groove 501 and two secondary grooves 502.

The cube-corner retroreflecting structure beneath the front surface 303 of the infrared retroreflecting stripe 301 can be of a pyramid-like structure formed by three right-angle triangles with their right angles connecting one another, as shown in FIG. 8. There are three angles formed in the bottom of the pyramid and the angles b and c are substantially the same; for example, b and c are about 54-56 °. The cube-corner structures underneath the front surface 303 may not be of the same size or formed of the same angles. The infrared retroreflecting stripe 301 is usually a stripe cut from a cube-corner retroreflecting sheet which a plurality of cube-corner structures are distributed thereon.

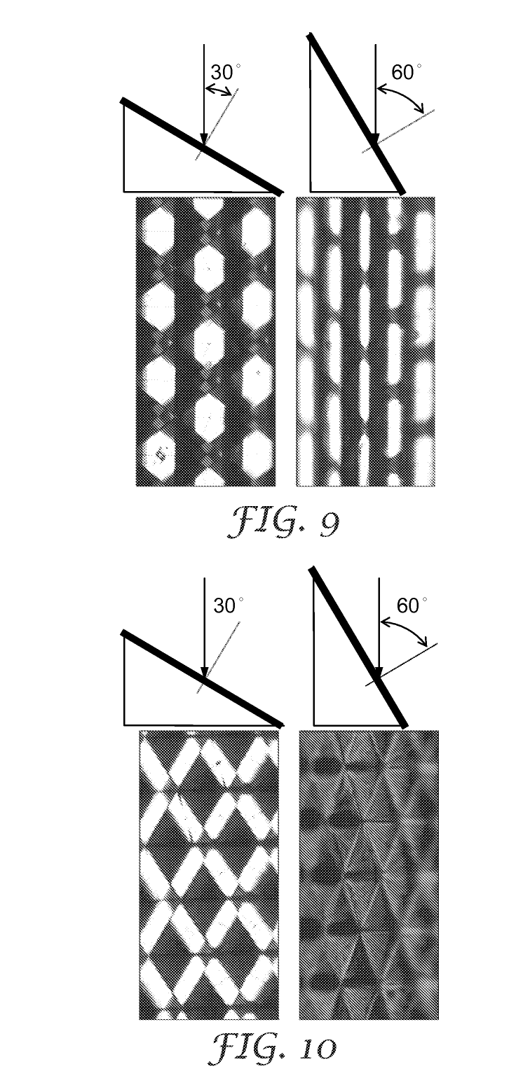

When the structure of the infrared retroreflecting stripe is obtained by cutting the cube-corner retroreflecting sheet in the second direction 602, and the infrared emitted from the infrared detectors 21, 22 arranged near two ends of the first edge 11 of the high-aspect-ratio panel reaches the front surface 303 of the infrared retroreflecting device 31, at the positions diagonal to the infrared detectors 21 and 22 (the incident angle θ′ is about 60.6°), the retroreflecting device 31 can reflect sufficient amount of infrared. Therefore, the infrared detectors 21, 22 can smoothly detect an object at any position on the touch screen. FIG. 9 is a photo showing that when the incident angle is in the range from about 30° to about 60°, the infrared retroreflecting structure can reflect sufficient amount of infrared. FIG. 10 shows a comparison result in which when the elongated axis X of the infrared retroreflecting stripe 301 is not perpendicular to the first direction 601 but to the second direction 602; namely, when the infrared retroreflecting stripe 301 is cut from an infrared retroreflecting structure sheet along the first direction 601 but not along the second direction 602, the cut infrared retroreflecting device 31 can reflect infrared at an incident angle of 30° but cannot reflect infrared at an incident angle of 60°.

As shown in FIG. 3, to make the color of the retroreflecting devices 31, 32 and 33 be consistent with that of the frame of a screen or panel, the whole cube-corner retroreflecting structure 5 or a portion of the cube-corner retroreflecting structure 5 within a certain depth beneath the front surface 303 can be dyed to have a specific color, for example, by adding a black or brown colorant into polymer material and then forming the cube-corner retroreflecting structure 5 accordingly. Alternatively, a layer of colored film 307 is disposed on the front surface 303. Normally, the colored film 307 is a dark resinous ink film, such as black or brown color. The colored film 307 or the formed colored cube-corner retroreflecting structure 5 allows the infrared to transmit therethrough, preferably allows infrared transmission of at least 70%, more preferably 80%. It can also have the function of absorbing visible light but should not influence the function of the infrared retroreflecting stripe 301.

If necessary, a backing layer 309 can be affixed to the back side 305 of the infrared retroreflecting stripe 301 of the retroreflecting devices 31, 32 and 33. The backing layer can be a plate-shaped article made of thermoplastic material for reinforcing the structure of the retroreflecting devices or providing a plate for spreading an adhesive thereon. For the convenience of disposing the infrared retroreflecting devices 31, 32 and 33 to the edges of the working area of the high-aspect-ratio panel, a layer of adhesive 311 is spread over the backing layer 309 thereof, such that the retroreflecting devices 31, 32 and 33 can be adhered to the second edge 12, the third edge 13 and the fourth edge 14, respectively.

As stated above, the infrared retroreflecting stripe 301 is cut from the cube-corner retroreflecting sheet in a specific direction. To facilitate the manufacturing process, it is preferable to spread or affix the colored film 307, backing layer 309 and adhesive layer 311 to the sheet material before cutting the infrared retroreflecting stripe 301 from the sheet material. For example, a sheet of the entire backing layer 309 can be affixed to the edges of the back side 305 of the entire cube-corner retroreflecting sheet by heat welding, such as high frequency welding, and then an adhesive layer 311 can be spread on the sheet of the entire backing layer 309. The adhesive layer 311 can be a heat-resistant pressure sensitive adhesive (PSA). Further, the aforementioned step of disposing a layer of colored film 307 on the front surface 303 can be proceeded with before or after the welding of the backing layer 309.

The cube-corner retroreflecting structure 5 can be modified by changing the tip of a cube-corner to a curved shape. The modifications would not depart from the spirit and important characteristics of the present invention. Therefore, the embodiments listed above are illustrative and not limitative in any way, and all variations fall within the scope of the present invention as long as they conform to the meaning and scope of the claims or their equivalents.

### LIST OF REFERENCE NUMERALS

1 Infrared optical touch panel

11 First edge

12 Second edge

13 Third edge

14 Fourth edge

21 Infrared detector

22 Infrared detector

31 Infrared retroreflecting device

32 Infrared retroreflecting device

33 Infrared retroreflecting device

5 Cube-corner retroreflecting structure

301 Infrared retroreflecting stripe

303 Front surface

305 Back side

307 Colored film

309 Backing layer

311 Adhesive layer

501 Primary groove

502 Secondary groove

601 First direction

602 Second direction

X Elongated axis

1. An infrared retroreflecting device used for a high-aspect-ratio optical touch panel, comprising:
an infrared retroreflecting stripe;
said stripe having a front surface, a back side and an elongated axis;
said stripe being formed of a cube-corner retroreflecting structure which has at least one primary groove and at least two secondary grooves and is beneath the front surface;
said primary groove being perpendicular to said elongated axis; and
said stripe reflecting infrared emitted toward the front surface when an infrared incident angle is ranged from about 0° to about 61°.

2. An infrared retroreflecting device according to claim 1, wherein the cube-corner retroreflecting structure is dyed within at least a certain depth beneath said front surface, and the dyed cube-corner retroreflecting structure allows infrared transmittance of at least 70%, optionally wherein the colored film is black or brown.

3. An infrared retroreflecting device according to claim 1, further comprising a colored film disposed on the front surface of the infrared retroreflecting stripe, said colored film allowing infrared transmittance of at least 70%, optionally wherein the dyed cube-corner retroreflecting structure is black or brown.

4. An infrared retroreflecting device according to claim 1, further comprising a backing layer affixed to the back side of said infrared retroreflecting stripe.

5. An infrared retroreflecting device according to claim 4, further comprising an adhesive layer disposed on one side of the backing layer opposite to the other side facing the back side of said infrared retroreflecting stripe.

6. An infrared retroreflecting device according to claim 5, wherein air is a material trapped in a space formed between the cube-corner retroreflecting structure of the infrared retroreflecting stripe and the backing layer.

7. A method of manufacturing an infrared retroreflecting device used for a high-aspect-ratio optical touch panel, comprising:
providing a cube-corner retroreflecting sheet which has a front surface, a back side, a first direction and a second direction, said first direction being perpendicular to the second direction, and
cutting a retroreflecting stripe from said cube-corner retroreflecting sheet in the second direction, optionally wherein the infrared retroreflecting stripe within at least a certain depth is preformed by dyed polymer material and the dyed cube-corner retroreflecting stripe allows infrared transmittance of at least 70%, and optionally wherein the dyed cube-corner retroreflecting stripe is black or brown.

8. The method of manufacturing an infrared retroreflecting device of claim 7, wherein before cutting a retroreflecting stripe from said cube-corner retroreflecting sheet in the second direction, the method further comprises affixing a backing layer to the back side of said infrared retroreflecting sheet.

9. The method of manufacturing an infrared retroreflecting device of claim 8, wherein before cutting a retroreflecting stripe from said cube-corner retroreflecting sheet in the second direction, the method further comprises providing a layer of adhesive on one side of the backing layer opposite to the other side facing the back side of said infrared retroreflecting sheet.

10. The method of manufacturing an infrared retroreflecting device of claim 9, wherein before cutting a retroreflecting stripe from said cube-corner retroreflecting sheet in the second direction, the method further comprises affixing a colored film over the front surface of the formed infrared retroreflecting sheet; said colored film allowing infrared transmittance of at least 70%, optionally wherein said colored film is black or brown.

11. The method of manufacturing an infrared retroreflecting device of claim 10, wherein the backing layer is affixed to the back side of said infrared retroreflecting sheet by heat welding the edges of the infrared retroreflecting sheet.

12. A high-aspect-ratio optical touch panel, comprising:
a first edge and a second edge opposite to the first edge;
a third edge and a fourth edge opposite to the third edge, both the third edge and fourth edge being perpendicular to the first edge and the second edge;
two infrared detectors located near two ends of the first edge of said panel, said infrared detectors being able to emit infrared to the second edge of said panel and receive the infrared,
an infrared retroreflecting device located at the second edge of said panel;
said infrared retroreflecting device having an infrared retroreflecting stripe, said stripe having a front surface facing the infrared detectors, a back side and an elongated axis;
said stripe being formed of a cube-corner retroreflecting structure which has at least one primary groove and at least two secondary grooves, and is beneath the front surface;
said primary groove being perpendicular to said elongated axis, and
the infrared retroreflecting device reflecting sufficient infrared from each location along the infrared retroreflecting device so that the reflected infrared can be detected by both of the infrared detectors.

13. The high-aspect-ratio optical touch panel of claim 12, wherein the aspect ratio of said panel is 16:9 and the maximum incident angle that the infrared detector emits infrared to the second edge is around 60.6°.

14. The high-aspect-ratio optical touch panel of claim 12, further comprising two infrared retroreflecting devices located on the third and fourth edges of the panel respectively with their front surfaces facing each other.

15. The high-aspect-ratio optical touch panel of claim 14, wherein each of these infrared retroreflecting devices has a colored film disposed over the front surface of the infrared retroreflecting stripe; said colored film allowing infrared transmittance of at least 70%, optionally wherein the colored film is black or brown.

16. The high-aspect-ratio optical touch panel of claim 15, wherein the cube-corner retroreflecting structure is dyed within at least a certain depth beneath said front surface, and the dyed cube-corner retroreflecting structure allows infrared transmittance of at least 70%.

17. The high-aspect-ratio optical touch panel of claim 15, wherein said infrared retroreflecting device has a backing layer affixed to the back side of said infrared retroreflecting stripe.

18. The high-aspect-ratio optical touch panel of claim 17, wherein said infrared retroreflecting device has an adhesive layer disposed over one side of the backing layer opposite to the other side facing the back side of said infrared retroreflecting stripe.

19. The high-aspect-ratio optical touch panel of claim 15, wherein said infrared retroreflecting device has a backing layer affixed to the back side of said infrared retroreflecting stripe and an adhesive layer disposed over one side of the backing layer opposite to the other side facing the back side of said infrared retroreflecting stripe.

20. A high-aspect-ratio optical touch panel, comprising:
a first edge and a second edge opposite to the first edge;
a third edge and a fourth edge opposite to the third edge, both the third edge and fourth edge being perpendicular to the first edge and the second edge;
two infrared detectors located near two ends of the first edge of said panel, said infrared detectors being able to emit infrared to the second edge of said panel and receive the infrared,
an infrared retroreflecting device located at the second edge of said panel; wherein
said infrared retroreflecting device is manufactured according to the method of of claim 7.
